(19) United States
(12) Patent Application Publication
(10) Pub. No.: US 2007/0098997 A1
(43) Pub. Date: May 3, 2007

(54) Composite articles and a process for their production

(75) Inventors: Usama E. Younes, McMurray, PA (US); James P. Kotar, McMurray, PA (US); James L. Lambach, McMurray, PA (US); John H. Perry, Scenery Hill, PA (US)

Correspondence Address: BAYER MATERIAL SCIENCE LLC, 100 BAYER ROAD, PITTSBURGH, PA, 15205, US

(73) Assignee: Bayer MaterialScience LLC

(21) Appl. No.: 11/264,890

(22) Filed: Nov. 2, 2005

(51) Int. Cl. B32B 27/40

(52) U.S. Cl. 428/423.1

(57) ABSTRACT

Weather resistant composite articles which have a smooth, bubble-free surface and are sufficiently puncture resistant to pass the DynaTup Instrument Impact Test are produced by an open pour process. These composites include a polyurethane, unreinforced barrier coat and a fiber-reinforced polyurethane layer. These composite articles are particularly useful for the production of doors and panels.

### BACKGROUND OF THE INVENTION

The present invention relates to fiber-reinforced composite articles which are sufficiently puncture resistant to pass the DynaTup Instrument Impact Test (described herein), are weather resistant and which have a smooth, bubble-free, defect-free surface and to a method for producing such composite articles. These composite articles are particularly useful for doors and panels.

Composite articles which are produced with fiber reinforced polymeric materials that are useful in construction applications such as doors, panels, and windows and for various components for automotive vehicles are known.

In U.S. Pat. No. 6,197,242, for example, fiber reinforced molded articles are produced with two separate fiber surfacing veils with a fiber reinforcement sandwiched between those surfacing veils and a polyurethane reaction system is injected into the mold. It is the fiber surfacing veils to which the smooth finish is attributed. This process is disadvantageous in that it requires the use of two different forms of reinforcing material. Additionally, the use of a surfacing veil is labor intensive and time consuming, results in wasted material due to the need for trimming and requires the additional step of pre-forming the veil to fit complex shapes.

U.S. Pat. No. 6,617,032 discloses composites made up of a polyurea show surface or top layer and a polyurethane backing layer. The top layer is the reaction product of an aliphatic, ultraviolet light stable polyisocyanate and a polyamine. The polyurethane backing layer is the reaction product of a polyisocyanate component and a polyol component. Neither of these disclosed layers is, however, reinforced with a material such as glass fibers. Consequently, these composites would not be suitable for use in applications such as doors.

U.S. Pat. No. 6,696,160 discloses polyurethane composite components useful in exterior bodywork parts. These composites are composed of a layer of polyurethane reinforced with short fibers having a paintable surface and a second layer of polyurethane reinforced with long fibers. The use of two fiber-reinforced layers is said to produce composites which are hard enough to resist scratching and have high heat distortion resistance.

Published Application US 20020195742 teaches that the surface quality problem of “print-through” (i.e., rough or irregular surface due to the presence of reinforcing fiber at the surface) encountered with composites made from fiber-reinforced materials may be resolved by applying to an appropriate mold surface a first coating formulation which will create an unreinforced barrier layer upon curing. A second formulation which includes a reinforcing material is then applied on top of the first coating formulation. These formulations are then cured to produce an article which is described as having a “Class A” surface finish. The issue of puncture resistance is not addressed in this disclosure. It is, however, taught in Application US 20020195742 that the disclosed barrier coats may not be suitable for outdoor use. Direct sunlight, heat, acid rain, and other weather-related effects may play a major role in degrading the finish of the surface. The need to use both a topcoat and a barrier layer is disadvantageous from both a cost and a processing perspective.

Published U.S. Patent Application 20040023050 discloses composite articles prepared by a spray operation in which a gel coat is applied to a mold surface, a barrier coat is applied over the gel coat in the mold and a laminate formula containing from 20 to 60% by weight reinforcing fibers is applied over the barrier coat. The gel coat contains a curable polyester polyurethane acrylate resin which is exposed to ultraviolet radiation for a prolonged period of time to produce a high gloss surface. The need to expose the gel coat to ultraviolet radiation and the need to use both a gel coat (for surface quality) and a barrier coat (to prevent shrinkage) are among the disadvantages of the process for producing composite articles disclosed in this patent application.

Published U.S. Patent Application 20040038059 discloses multilayer composites which can be made using an open tool molding process. A key feature of these disclosed composites is the barrier coat which is composed of a cured polyester resin containing reinforcing fibers shorter than those in the laminate layer. Among the disadvantages of these disclosed composites is the need to use two different reinforcing fibers.

However, these known composites have not been considered commercially desirable for applications such as entry doors for houses because they were not sufficiently puncture resistant. Many of these composites also lack the surface quality necessary for many applications.

### SUMMARY OF THE INVENTION

It is an object of the present invention to provide composite articles having a smooth surface which are sufficiently puncture resistant to be useful for construction applications such as entry doors and to a process for the production of such articles.

It is also an object of the present invention to provide an open pour process for making composite articles.

It is a further object of the present invention to provide a process for making relatively large composite articles having good surface quality and excellent mechanical properties, particularly, puncture resistance.

These and other objects which will be apparent to those skilled in the art are accomplished by: (1) applying to a mold surface, preferably by spraying, a polyurethane/polyurea-forming system composed of materials specified herein in amount such that a barrier coat which is at least 5 mils thick will form within a short amount of time, preferably within 30 seconds; (2) applying to the exposed surface of the barrier coat a second fiber-containing polyurethane/polyurea-forming system composed of materials specified herein; and (3) allowing the polyurethane/polyurea-forming systems to cure. The ratio of the weight of the barrier coat to the weight of the fiber-reinforced layer will generally be from about 0.05 to about 0.4.

### DETAILED DESCRIPTION OF THE INVENTION

The present invention is directed to a process for producing composite articles which are characterized by excellent puncture resistance and a smooth surface and to the composite articles produced by this process.

The composite articles of the present invention are made up of at least two layers. The first required layer or barrier coat is a polyurethane/polyurea composition which does not include any reinforcing materials such as glass fibers or fillers. The second required layer is a polyurethane/polyurea composition which is different from that of the barrier coat and must include a reinforcing fibrous material. The ratio of the weight of the barrier coat to the weight of the fiber-reinforced layer will generally be from about 0.05 to about 0.4, preferably, from about 0.1 to about 0.4, most preferably, from about 0.15 to about 0.25.

The first layer or barrier coat is a polyurethane composition which is the reaction product of (1) a polyisocyanate component that must include an isocyanate-terminated prepolymer having an NCO content of from about 10 to about 32% by weight, preferably, from about 16 to about 32% by weight, most preferably from about 18 to about 31% by weight and (2) an isocyanate-reactive component which must include at least one amine-initiated polyether polyol having a functionality greater than 2, preferably, from about 3 to about 6, most preferably, from about 3 to about 4 and an OH number of from about 60 to about 700, preferably, from about 130 to about 700, most preferably, from about 140 to about 650. This barrier coat is applied to a surface such as a mold surface, in an amount such that the cured barrier coat will have a thickness of at least 5 mils, preferably, from about 8 to about 20 mils, most preferably, from about 8 to about 12 mils. The barrier coat polyurethane/polyurea-forming system must be capable of curing within a short amount of time, preferably, in less than 30 seconds, more preferably less than 10 seconds so that it will be substantially cured before application of the second, reinforced polyurethane/polyurea composition.

The isocyanate-terminated prepolymer required for the barrier coat composition may be produced from any of the known polyisocyanates having at least two isocyanate groups. Such isocyanates include aromatic, aliphatic, and cycloaliphatic polyisocyanates and combinations thereof. Useful isocyanates include: diisocyanates such as m-phenylene diisocyanate, p-phenylene diisocyanate, 2,4-toluene diisocyanate, 2,6-toluene diisocyanate, 1,6-hexamethylene diisocyanate, 1,4-hexamethylene diisocyanate, 1,3-cyclohexane diisocyanate, 1,4-cyclohexane diisocyanate, hexahydrotoluene diisocyanate and its isomers, isophorone diisocyanate, dicyclohexylmethane diisocyanates, 1,5-naphthalene diisocyanate, 1-methylphenyl-2,4-phenyl diisocyanate, 4,4′-diphenylmethane diisocyanate, 2,4′-diphenylmethane diisocyanate, 4,4′-biphenylene diisocyanate, 3,3′-dimethoxy-4,4′-biphenylene diisocyanate and 3,3′-dimethyl-4,4′-biphenylene diisocyanate; triisocyanates such as 2,4,6-toluene triisocyanate; and polyisocyanates such as 4,4′-dimethyldiphenylmethane-2,2′,5,5′-tetraisocyanate and the polymethylene polyphenylpolyisocyanates.

Undistilled or crude polyisocyanate may also be used. The crude toluene diisocyanate obtained by phosgenating a mixture of toluene diamines and the diphenylmethane diisocyanate obtained by phosgenating crude diphenylmethanediamine (polymeric MDI) are examples of suitable crude polyisocyanates. Suitable undistilled or crude polyisocyanates are disclosed in U.S. Pat. No. 3,215,652.

It is preferred, however, that the polyisocyanate be an aromatic polyisocyanate which is commercially available such as any of those polyisocyanates available from Bayer MaterialScience under the names Mondur M, Mondur ML, Mondur MR, Mondur MRS, Mondur MA2903, Mondur PF, Mondur MRS2 and combinations thereof.

The most preferred polyisocyanates for the production of the prepolymer used to produce the barrier coat of the present invention are prepolymers of diphenylmethane diisocyanate and methylene-bridged polyphenyl polyisocyanates.

Prepolymers based on polyether polyols or polyester polyols and diphenylmethane diisocyanate are particularly preferred. Processes for the production of prepolymers from the above-described diisocyanates and polyisocyanates are known in the art.

The polyisocyanate component which includes the required prepolymer is then reacted with an isocyanate-reactive component that includes at least one amine-initiated polyether polyol having a functionality greater than 2 and a number average molecular weight of from about 150 to about 700. The amine initiator used to produce this polyether polyol may be selected from any of the amines known to be useful for this purpose, preferably, from toluene diamine, ethanol amine, ethylene diamine, and triethylene amine. This amine initiator is alkoxylated, generally with ethylene oxide and/or propylene oxide, although any of the known alkoxylating materials may be used, in accordance with techniques known to those skilled in the art.

In addition to the amine-initiated polyether polyol, the isocyanate-reactive component may also include any compound containing hydroxyl, amino, and/or thiol groups having a functionality of at least 2 and an OH Number of from about 260 to about 1100. Examples of suitable isocyanate-reactive materials include: polyether polyamines, polyether polyols initiated with a material other than an amine, polyester polyols, polyether-ester polyols, polymer polyols, polythioether polyols, polyesteramides, hydroxyl group-containing polyacetals, and hydroxyl-group-containing polycarbonates, and combinations thereof. Polyether polyols prepared from hydroxyl-group containing initiators are particularly preferred.

The isocyanate-reactive component used to produce the barrier coat may also contain any of the known chain extenders, crosslinking agents, catalysts, release agents, pigments, surface-active compounds and/or stabilizers and any other auxiliary agents or processing aids commonly used in such systems with the exception of fibers and fillers.

Examples of suitable chain extenders include: 1,4-butane diol, propylene glycol, ethylene glycol, dipropylene glycol, 1,6-hexanediol, and hydroquinone dihydroxy ethyl ether, preferably, ethylene glycol. Suitable crosslinking agents include glycerin and diethyltoluenediamine. Suitable catalysts include: dibutyltindilaurate, tin octoate, tetramethylbutanediamine, and 1,4-diaza-(2,2,2)-bicyclooctane. Suitable release agents include fatty acid esters and silicones. Examples of suitable pigments include: carbon black, titanium dioxide and organic pigments. Examples of suitable surface-active compounds and/or stabilizers include hindered amines and vitamin E.

In a particularly preferred embodiment of the present invention, the isocyanate-reactive component used to produce the barrier coat includes: (1) from about 8 to about 18 wt % (based on total weight of isocyanate-reactive component) of an amine-initiated polyether polyol having a functionality of approximately 4 and a hydroxyl number of from 500-700; (2) from about 12-32 wt % (based on total weight of isocyanate-reactive component) of an amine-initiated polyether polyol having a functionality of approximately 3 and a hydroxyl number of from about 100 to 200; (3) from about 34 to about 54 wt % (based on total weight of isocyanate-reactive component) of a polymer polyol; (4) from about 13-23 wt % (based on total weight of isocyanate-reactive component) of a chain extender; and optionally, (5) a catalyst.

The barrier composition is formed by reacting the isocyanate-terminated prepolymer with the isocyanate-reactive component in which the amine-initiated polyether polyol is present at an NCO/OH equivalent ratio of from about 0.8 to about 1.4, preferably, from about 0.9 to about 1.2, most preferably, from about 1.0 to about 1.1.

The barrier coat of the present invention will usually have a hardness value of from about 60 Shore A to about 95 Shore D, preferably, from about Shore D to about 60 Shore D.

This barrier coat-forming reaction mixture is applied to a surface in an amount sufficient to form a barrier coat having a thickness of at least 5 mils, preferably, from about 8 to about 12 mils when fully reacted and cured. Application of the barrier coat may be carried out by any of the known methods which will produce a substantially defect-free surface. Examples of suitable methods include pouring and spraying. Spraying is the preferred method.

The second fiber-reinforced polyurethane/polyurea required layer of the composites of the present invention is produced from: (1) a polyisocyanate component which includes at least one polyisocyanate having an NCO content of from about 6 to about 49%, preferably, from about 20 to about 50, more preferably from about 23 to about 34, most preferably from about 28 to about 32; (2) an isocyanate-reactive component which includes: (i) at least one polyether polyol initiated with a hydroxyl-group containing starter and having a functionality of 2 or greater, preferably, from about 2 to about 6, more preferably, from about 2 to about 4, most preferably, from about 2 to about 3 and a hydroxyl number of from about 28 to about 1100, preferably from about 400 to about 1100, most preferably, from about 260 to about 1050, and/or (ii) at least one amine-initiated polyether polyol having a functionality greater than 2, preferably, from about 2 to about 8, more preferably, from about 3 to about 6, most preferably, from about 3 to about 4, and a hydroxyl number of from about 50 to about 1100, preferably, from about 300 to about 900, most preferably, from about 400 to about 700; and (3) a filler, preferably, a long glass fiber.

Any of the known polyisocyanates or modified polyisocyanates having the required NCO content may be used in the polyisocyanate component used to produce the fiber reinforced layer of the composites of the present invention. Suitable isocyanates include the known organic isocyanates, modified isocyanates or isocyanate-terminated prepolymers made from any of the known organic isocyanates. Such isocyanates include aromatic, aliphatic, and cycloaliphatic polyisocyanates and combinations thereof. Useful isocyanates include: diisocyanates such as m-phenylene diisocyanate, p-phenylene diisocyanate, 2,4-toluene diisocyanate, 2,6-toluene diisocyanate, 1,6-hexamethylene diisocyanate, 1,4-hexamethylene diisocyanate, 1,3-cyclohexane diisocyanate, 1,4-cyclohexane diisocyanate, hexahydrotoluene diisocyanate and its isomers, isophorone diisocyanate, dicyclohexylmethane diisocyanates, 1,5-naphthalene diisocyanate, 1-methylphenyl-2,4-phenyl diisocyanate, 4,4′-diphenylmethane diisocyanate, 2,4′-diphenylmethane diisocyanate, 4,4′-biphenylene diisocyanate, 3,3′-dimethoxy-4,4′-biphenylene diisocyanate and 3,3′-dimethyl-4,4′-biphenylene diisocyanate; triisocyanates such as 2,4,6-toluene triisocyanate; and polyisocyanates such as 4,4′-dimethyldiphenylmethane-2,2′,5,5′-tetraisocyanate and the polymethylene polyphenylpolyisocyanates.

Undistilled or crude polyisocyanate may also be used. The crude toluene diisocyanate obtained by phosgenating a mixture of toluene diamines and the diphenylmethane diisocyanate obtained by phosgenating crude diphenylmethanediamine (polymeric MDI) are examples of suitable crude polyisocyanates. Suitable undistilled or crude polyisocyanates are disclosed in U.S. Pat. No. 3,215,652.

Modified isocyanates are obtained by chemical reaction of diisocyanates and/or polyisocyanates. Modified isocyanates useful in the practice of the present invention include isocyanates containing ester groups, urea groups, biuret groups, allophanate groups, carbodiimide groups, isocyanurate groups, uretdione groups and/or urethane groups. Preferred examples of modified isocyanates include prepolymers containing NCO groups and having an NCO content of from about 6 to about 49% by weight, preferably from about 23 to about 32%, most preferably, from about 18 to about 30% by weight. Prepolymers based on polyether polyols or polyester polyols and diphenylmethane diisocyanate are particularly preferred. Processes for the production of these prepolymers are known in the art.

The most preferred polyisocyanates for the production of rigid polyurethanes are methylene-bridged polyphenyl polyisocyanates and prepolymers of methylene-bridged polyphenyl polyisocyanates having an average functionality of from about 2 to about 3.5 (preferably from about 2.2 to about 2.9) isocyanate moieties per molecule and an NCO content of from about 23 to about 32% by weight (preferably from about 28 to about 32%).

The isocyanate-reactive component used to produce the fiber reinforced polyurethane/polyurea layer must include: (i) at least one alkylene oxide polyether polyol prepared from an initiator which is not an amine (e.g., any of the known hydroxyl group-containing starters) having a hydroxyl functionality greater than 2, preferably from about 2 to about 6, most preferably, from about 3 to about 4 and a hydroxyl number of at least 28, preferably, from about 28 to about 1100, most preferably, from about 260 to about 1050 and/or (ii) at least one amine-initiated polyether polyol having a functionality greater than 2, preferably, from about 2 to about 6, most preferably, from about 2 to about 4, and a hydroxyl number greater than 50, preferably, from about 50 to about 1100, most preferably, from about 400 to about 700. The amine initiator used to produce such polyether polyether polyols may be any of the known aliphatic or aromatic amines having an amino functionality of at least 2. Preferred amine initiators include: toluene diamine, ethanol amine, ethylene diamine and triethylene amine. Such alkylene oxide-based polyether polyols and amine-initiated polyether polyols are commercially available and methods for producing them are known to those skilled in the art.

Examples of suitable alkylene oxide-based polyether polyols which are commercially available include those which are available from Bayer MaterialScience under the names Multranol 9158, Multranol 9139, Arcol PPG425, Arcol LG650 and Multranol 9171.

Examples of suitable amine-initiated polyether polyols which are commercially available include those which are available from Bayer MaterialScience under the names Multranol 4050, Multranol 9138, Multranol 9170, and Multranol 9181.

In addition to the required polyol(s), any of the other known polyols may also be included. Suitable organic materials containing two or more hydroxyl groups and having molecular weights of from about 400 to about 6000 include polyols such as polyester polyols, polyether polyols, polyhydroxy polycarbonates, polyhydroxy polyacetals, polyhydroxy polyacrylates, polyhydroxy polyester amides and polyhydroxy polythioethers. Polyester polyols, polyether polyols and polyhydroxy polycarbonates are preferred.

Suitable polyester polyols include the reaction products of polyhydric alcohols (preferably dihydric alcohols to which trihydric alcohols may be added) and polybasic (preferably dibasic) carboxylic acids. In addition to these polycarboxylic acids, corresponding carboxylic acid anhydrides or polycarboxylic acid esters of lower alcohols or mixtures thereof may also be used to prepare the polyester polyols useful in the practice of the present invention. The polycarboxylic acids may be aliphatic, cycloaliphatic, aromatic and/or heterocyclic and they may be substituted, e.g. by halogen atoms, and/or unsaturated. Examples of suitable polycarboxylic acids include: succinic acid; adipic acid; suberic acid; azelaic acid; sebacic acid; phthalic acid; isophthalic acid; trimellitic acid; phthalic acid anhydride; tetrahydrophthalic acid anhydride; hexahydrophthalic acid anhydride; tetrachlorophthalic acid anhydride, endomethylene tetrahydrophthalic acid anhydride; glutaric acid anhydride; maleic acid; maleic acid anhydride; fumaric acid; dimeric and trimeric fatty acids such as oleic acid, which may be mixed with monomeric fatty acids; dimethyl terephthalates and bis-glycol terephthalate. Suitable polyhydric alcohols include: ethylene glycol; 1,2- and 1,3-propylene glycol; 1,3- and 1,4-butylene glycol; 1,6-hexanediol; 1,8-octanediol; neopentyl glycol; cyclohexanedimethanol; (1,4-bis(hydroxymethyl)cyclohexane); 2-methyl-1,3-propanediol; 2,2,4-trimethyl-1,3-pentanediol; triethylene glycol; tetraethylene glycol; polyethylene glycol; dipropylene glycol; polypropylene glycol; dibutylene glycol and polybutylene glycol, glycerine and trimethylolpropane. The polyesters may also contain a portion of carboxyl end groups. Polyesters of lactones, e.g.—caprolactone or hydroxyl carboxylic acids such as ω-hydroxycaproic acid, may also be used.

Suitable polycarbonates containing hydroxyl groups include those obtained by reacting diols with phosgene, a diarlycarbonate (e.g., diphenyl carbonate) or cyclic carbonates (e.g., ethylene or propylene carbonate). Examples of suitable diols include: 1,3-propanediol; 1,4-butanediol; 1,6-hexanediol; diethylene glycol; triethylene glycol; and tetraethylene glycol. Polyester carbonates obtained by reacting polyesters or polylactones (such as those described above) with phosgene, diaryl carbonates or cyclic carbonates may also be used in the practice of the present invention.

Polyether polyols which are suitable include those obtained in known manner by reacting one or more starting compounds which contain reactive hydrogen atoms with alkylene oxides such as ethylene oxide, propylene oxide, butylene oxide, styrene oxide, tetrahydrofuran, epichlorohydrin or mixtures of these alkylene oxides. Polyethers which do not contain more than about 10% by weight of ethylene oxide units are preferred. Polyethers obtained without the addition of ethylene oxide are most preferred. Suitable starting compounds containing reactive hydrogen atoms include polyhydric alcohols (described above as being suitable for preparing polyester polyols); water; methanol; ethanol; 1,2,6-hexane triol; 1,2,4-butane triol; trimethylol ethane; pentaerythritol; mannitol; sorbitol; methyl glycoside; sucrose; phenol; isononyl phenol; resorcinol; hydroquinone; and 1,1,1- or 1,1,2-tris-(hydroxyl phenyl )-ethane.

Polyethers modified by vinyl polymers are also suitable for the present invention. Such modified polyethers may be obtained, for example, by polymerizing styrene and acrylonitrile in the presence of a polyether (U.S. Pat. Nos. 3,383,351; 3,304,273; 3,523,095; 3,110,695 and German Patent No. 1,152,536).

The polythioethers useful in the present invention include the condensation products obtained from thiodiglycol on its own and/or with other glycols, dicarboxylic acids, formaldehyde, aminocarboxylic acids or amino alcohols. These condensation products may be polythio-mixed ethers, polythioether esters or polythioether ester amides, depending on the co-components.

Amine-terminated polyether useful in the present invention may be prepared by reacting a primary amine with a polyether containing terminal leaving groups such as halides, or mesylates as disclosed in commonly assigned U.S. patent application Ser. No. 07/957,929, filed on Oct. 7, 1992, or as disclosed in U.S. Pat. Nos. 3,666,726, 3,691,112 and 5,066,824.

Suitable polyacetals include those prepared from aldehydes (e.g., formaldehyde) and glycols such as diethylene glycol, triethylene glycol, ethoxylated 4,4′-dihydroxydiphenyldimethylmethane, and 1,6-hexanediol. Polyacetals prepared by the polymerization of cyclic acetals may also be used in the practice of the present invention.

Polyhydroxy polyester amides and polyamines useful in the present invention include the predominantly linear condensates obtained from polybasic saturated and unsaturated carboxylic acids or their anhydrides and polyvalent saturated or unsaturated aminoalcohols, diamines, polyamines and mixtures thereof.

Suitable monomers for producing hydroxy-functional polyacrylates include acrylic acid, methacrylic acid, crotonic acid, maleic anhydride, 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, glycidyl acrylate, glycidyl methacrylate, 2-isocyanatoethyl acrylate and 2-isocyanatoethyl methacrylate.

The low molecular weight, isocyanate-reactive compounds useful in the present invention have from about 2 to about 6 hydroxyl groups, preferably two hydroxyl groups, and have an average molecular weight of from about 60 to about 200, preferably from about 80 to about 150 and may be used in combination with or instead of the high molecular weight material containing two or more hydroxyl groups. Useful low molecular weight isocyanate-reactive materials include the polyhydric alcohols which have previously been described in the process for the preparation of the polyester polyols and polyether polyols. Dihydric alcohols are preferred.

In addition to the above-mentioned isocyanate-reactive compounds, monofunctional and even small amounts of trifunctional and higher functional compounds generally known in polyurethane chemistry may be used. For example, trimethylolpropane may be used in special cases in which slight branching is desired.

Catalysts may be used to aid the polyurethane/polyurea-forming reaction. Examples of catalysts useful for promoting such reactions include di-n-butyl tin dichloride, di-n-butyl tin diacetate, di-n-butyl tin dilaurate, triethylenediamine, bismuth nitrate, tin octoate and tetramethyl butanediamine.

In addition to the isocyanate-reactive materials, a reinforcing material is also included in the isocyanate-reactive component. This reinforcing material is preferably in the form of fibers. Suitable fibers have an average length of from about 10 to about 100 mm, preferably, from about 12.5 to about 25 mm. Suitable fibrous materials include: glass fibers; carbon fibers; ceramic fibers; natural fibers such as flax, jute, and sisal; synthetic fibers such as polyamide fibers, polyester fibers and polyurethane fibers. The fibrous material is generally included in an amount of from about 10 to about 60 wt %, based on total weight of isocyanate-reactive component, preferably, from about 20 to about 50 wt. %, most preferably, from about 25 to about 40 wt. %.

The composite articles of the present invention may have a solid or a foamed fiber-reinforced layer. A foamed layer may be obtained by including a blowing agent in the reaction mixture from which the fiber-reinforced layer is produced.

In a particularly preferred embodiment of the present invention, the isocyanate component of the second, reinforced layer may be any commercially available polymeric MDI having the required NCO content, such as those available from Bayer MaterialScience under the names Mondur MRS, Mondur MR or Mondur MRS4. The isocyanate-reactive component includes: (1) a polyether polyol which is the propoxylation product of glycerin having a functionality of approximately 3 and an OH Number of from 28 to 1100; and (2) an amine-initiated polyether polyol in which the amine initiator is an aromatic amine having a functionality of from 3 to 4 and an OH Number of from 50 to 1100. From about 25 to about 40 wt %, based on total weight of reaction mixture, of glass fibers having an average length of from about 12.5 to 25 mm may be included in the isocyanate-reactive component or may be added to the total reaction mixture either as the isocyanate and isocyanate reactive components are combined or after they have been combined. It is most preferred that the fiber be combined with the reaction mixture as the isocyanate and isocyanate-reactive components are combined.

The second, reinforced layer of the composites of the present invention are generally produced with a reaction mixture in which the NCO to OH equivalent ratio is from about 0.95 to about 1.3, preferably, from about 1.0 to about 1.1.

While the composites of the present invention may be produced in accordance with any of the known techniques, they are generally produced by an open-pour molding technique in which the barrier coat is applied by spraying and the reaction mixture that will form the second, reinforced layer is poured onto the barrier coat, preferably, after that barrier coat is substantially fully reacted.

The barrier coat must be such that upon curing the barrier coat and the fiber-reinforced layer bond together in a manner and to an extent such that the barrier coat and the fiber reinforced layer form an acceptable bond between the layers that will resist delamination or other degradation during use within the intended service environment. Before spraying or otherwise applying the barrier coat-forming reaction mixture to a surface such as a mold surface, the mold may be heated, preferably to a temperature of between approximately 37 degrees Celsius and approximately 94 degrees Celsius. However, such heating is not required. Processing temperatures of reactants, reaction mixtures and mold are chosen in accordance with techniques known to those skilled in the art to provide the desired speed of composite processing.

After application of the barrier coat to the surface, the fiber-containing reaction mixture is poured or otherwise placed on top of the barrier coat. Long fiber injection is a particularly preferred method. Apparatus and processing parameters for such long fiber injection are disclosed, e.g., in U.S. Published Patent Application 2004/0135280. The layered contents of the mold may be cured. The composites of the present invention may be fabricated using an open or closed mold.

The composite articles produced in accordance with the present invention are generally produced in a mold. Suitable molds may be made of steel, aluminum, or nickel. Molds having shear edges are particularly preferred because of their improved seal and simplification of the product trimming process.

In producing composites in accordance with a particularly preferred embodiment of the present invention, the barrier coat-forming reaction mixture will generally be sprayed to a mold surface at a rate of from about 40 to about 70 grams of reaction mixture per second. To be able to apply the reaction mixture at this rate and to achieve the desired barrier coat thickness of at least 5 mils, it will generally be necessary to heat both the isocyanate component and the isocyanate-reactive component (also referred to in this discussion as the “polyol component”) to a temperature of from about 120 to about 160° F. Typical spraying pressures for proper mixing and application will generally range from about 2,000 to about 2,500 psi. The specific conditions to be used will, however, be dependent upon the particular equipment spray equipment being used. Suitable spray equipment is commercially available from GRACO, Glas-Craft, GUSMER-DECKER, Isotherm and BINKS.

The temperature of the mold surface onto which the barrier coat-forming mixture is sprayed is not critical for proper application and cure of the barrier coat. The mold temperature is important for the proper curing of the reinforcing layer which is applied to the barrier coat.

A mold release will generally be used to assure acceptable demolding of the composite article.

While the fiber-containing reaction mixture which will form the reinforcing layer of the composites of the present invention may be applied to the barrier coat by a variety of methods, long fiber injection (“LFI”) is a particularly advantageous method.

In the LFI process, an open mold is charged from a mixhead in which fiberglass strands cut from the roving and the polyurethane reaction mixture are combined. The volume and length of the glass fibers can be adjusted at the mixhead. This process uses lower cost fiberglass roving rather than mats or preforms. The glass roving is preferably fed to a mixhead equipped with a glass chopper. The mixhead simultaneously dispenses the polyurethane reaction mixture and chops the glass roving as the mixhead is positioned over the mold and the contents of the mixhead are dispensed into the open mold. When the contents of the mixhead have been dispensed into the mold, the mold is closed, the reaction mixture is allowed to cure and the composite article is removed from the mold. The mold is generally maintained at a temperature of from about 120 to 190° F. The time needed to dispense the contents of the mixhead into the mold will usually be between 10 and 60 seconds. The mold will generally remain closed for a period of from about 1.5 to about 6 minutes to allow the glass fiber reinforced layer to cure.

The advantages of the process of the present invention, particularly when conducted using a fully automated system include: the ability to use lower cost fiberglass rovings instead of mats; the ability to vary the amount of glass reinforcement in a part; the ability to use either foamed or solid polyurethane as the reinforcing layer; and the ability to produce composite articles with a polyurethane in-mold coating and thereby eliminate secondary painting operations.

Having thus described our invention, the following Examples are given as being illustrative thereof. All parts and percentages given in these Examples are parts by weight or percentages by weight, unless otherwise indicated.

### EXAMPLES

### Materials Useful in the Production of the Barrier Coat and Fiber Reinforced Components in Accordance with the Present Invention Include

POLY A: a polymer polyol having an OH Number of approximately 27 mg KOH/g which is commercially available from Bayer MaterialScience LLC under the designation Arcol 24-38.
POLY B: An amine-based tetrafunctional polyether polyol having an OH Number of approximately 630 mg KOH/g which is commercially available from Bayer MaterialScience LLC under the name Multranol 4050.
POLY C: An amine-based trifunctional polyether polyol having an OH Number of approximately 150 mg KOH/g which is commercially available from Bayer MaterialScience LLC under the name Multranol 9144.
POLY D: A polyoxypropylene triol modified with ethylene oxide having an OH Number of approximately 36 mg KOH/g which is commercially available from Bayer MaterialScience under the name Multranol 3900.
POLY E: A trifunctional, amine-initiated polyether polyol having an OH Number of approximately 350 mg KOH/g which is available from Bayer MaterialScience under the name Multranol 9170.
POLY F: A polypropylene oxide-based diol modified with ethylene oxide having an OH Number of approximately 28 mg KOH/g which is available from Bayer MaterialScience under the name Multranol 9111.
POLY G: An amine-initiated polyether tetrol having an OH Number of approximately 460 mg KOH/g which is commercially available from Bayer MaterialScience LLC under the name Multranol 4063.
POLY H: An amine-initiated polyether triol having an OH Number of approximately 700 mg KOH/g which is commercially available from Bayer MaterialScience LLC under the name Multranol 9138.
POLY I: A polypropylene oxide-based triol modified with ethylene having an OH Number of approximately 470 mg KOH/g which is commercially available from Bayer MaterialScience under the name Multranol 9158.
POLY J: A polypropylene oxide-based triol modified with ethylene oxide having an OH Number of approximately 380 mg KOH/g which is commercially available from Bayer MaterialScience under the name Multranol 4035.
POLY K: A polypropylene oxide-based hexol, having an OH Number of approximately 340 mg KOH/g which is commercially available from Bayer MaterialScience under the name Multranol 9171.
POLY L: A polypropylene oxide-based diol having an OH Number of approximately 264 mg KOH/g which is commercially available from Bayer MaterialScience under the name ARCOL PPG425.
POLY M: A polypropylene oxide-based triol having an OH Number of approximately 655 mg KOH/g which is commercially available from Bayer MaterialScience under the name ARCOL PPG LG-650.
POLY N: A polypropylene oxide-based triol having an OH Number of approximately 1050 mg KOH/g which is commercially available from Bayer MaterialScience under the name Multranol 9133.
POLY O: An amine-initiated polyether tetrol having an OH Number of approximately 395 mg KOH/g which is commercially available from Bayer MaterialScience under the name Multranol 8114.
POLY P: An amine-initiated polyether tetrol having an OH Number of approximately 360 mg KOH/g which is commercially available from Bayer MaterialScience under the name Multranol 8120.
POLY Q: A polypropylene oxide-based triol having an OH Number of approximately 875 mg KOH/g which is commercially available from Bayer MaterialScience under the name Multranol 8108.
BDO: 1,4-butanediol.
EG: Ethylene glycol.
DEG: Diethylene glycol.
DTDA: Diethyltoluenediamine.
PU-1748: A quaternary ammonium salt of the amide of tall oil and N,N′-dimethyl-1,3-diamine propane.
MRA: Mold release agent which is commercially available from Henkel under the name Loxiol G-71S.
CAT A: A triethylene diamine catalyst which is commercially available from Air Products under the name Dabco 33LV.
CAT B: A tertiary amine catalyst which is commercially available from Air Products under the name Dabco 1028.
CAT C: A tin catalyst which is commercially available from Air Products under the name Dabco T12.
CAT D: An amine blow catalyst which is commercially available from Air Products under the name of Dabco BL17.
CAT E: An amine catalyst which is commercially available from Air Products under the name Dabco EG.
Stab: A sterically hindered amine light stabilizer which is commercially available from Ciba under the name Tinuvin 765.
UVA: A benzotriazole UV absorber which is commercially available from Ciba under the name Tinuvin 213.
AO 1: A hindered phenol antioxidant which is commercially available from Ciba under the name Irganox 1135.
FILLER: Continuous glass roving of 2400-available from Owens Corning under the name ME1020, and from Saint Gobain under the name Vetrotex 5249.
NCO A: An aromatic polymeric isocyanate based on diphenylmethane diisocyanate having an NCO content of 31% by weight and a viscosity at 25° C. of 160 MPa which is commercially available from Bayer MaterialScience LLC under the name Mondur 645A.
NCO B: A modified polymeric diphenylmethane diisocyanate (“PMDI”) isocyanate-terminated prepolymer having an NCO content of 19% and a viscosity at 25° C. of 500 MPa·s which is commercially available from Bayer MaterialScience under the name Baytec MP-190.
NCO C: A modified diphenylmethane diisocyanate (MDI) isocyanate-terminated prepolymer modified with polypropylene ether glycol having an NCO content of 21% which is commercially available from Bayer MaterialScience under the name Baytec MP-210.
NCO D: An aromatic isocyanate-terminated polymeric isocyanate based on diphenylmethane diisocyanate having an NCO content of 32% and a viscosity at 25° C. of 40 MPa·s which is commercially available from Bayer MaterialScience under the name Bayfit 753X-A.
NCO E: An aromatic isocyanate-terminated prepolymer based on diphenylmethane diisocyanate having an NCO content of 23% and a viscosity at 25° C. of 750 MPa·s which is commercially available under the name Mondur PF.
NCO F: A modified isocyanate-terminated aromatic isocyanate based on diphenylmethane diisocyanate having an NCO content of 23 and a viscosity at 25° C. of 550 MPa·s which is commercially available from Bayer MaterialScience under the name Mondur MA 2300.

Formulations which may be useful for the production of composite articles by the above-described procedure are given in the following Table.

| TABLE | | | | | | | | | | | | | | |
|---|---|---|---|---|---|---|---|---|---|---|---|---|---|---|
| Ex. | | | | | | | | | | | | | | |
| 1 | 2 | 3 | 4 | 5 | 6 | 7 | 8 | 9 | 10 | 11 | 12 | 13 | 14 | 15 |

Bar
Coat¹

| | | | | | | | | | | | | | | | |
|---|---|---|---|---|---|---|---|---|---|---|---|---|---|---|---|
| POLY | — | 40.7 | 52.5 | — | — | 47.5 | — | — | — | 7 | 52.5 | 44 | — | 7 | — |
| A, pbw | | | | | | | | | | | | | | | |
| POLY | — | 10 | 10 | — | — | 10 | — | — | — | — | 10 | 13.5 | — | — | — |
| B, pbw | | | | | | | | | | | | | | | |
| POLY | 85 | 10 | 20 | 60 | — | 25 | 90 | 85 | 55 | 75 | 20 | 22 | 60 | 75 | 55 |
| C, pbw | | | | | | | | | | | | | | | |
| POLY | — | — | — | — | 81.5 | — | — | — | — | — | — | — | — | — | — |
| D, pbw | | | | | | | | | | | | | | | |
| POLY | — | — | — | 30 | — | — | — | — | 30 | 10 | — | — | 30 | 10 | 30 |
| E, pbw | | | | | | | | | | | | | | | |
| POLY | — | 17.7 | — | — | — | — | — | — | — | — | — | — | — | — | — |
| F, pbw | | | | | | | | | | | | | | | |
| DTDA, | 13 | 19 | 15 | 9.8 | — | 15 | 7.8 | 13 | 9.8 | 7 | 15 | 17.6 | 9.8 | 7 | 9.8 |
| pbw | | | | | | | | | | | | | | | |
| BDO, | — | — | — | — | 18.5 | — | — | — | — | — | — | — | — | — | — |
| pbw | | | | | | | | | | | | | | | |
| Stab, | 1 | 1 | 1 | — | 1 | 1 | 1 | 1 | — | 1 | 1 | 1 | — | 1 | — |
| pbw | | | | | | | | | | | | | | | |
| UVA, | 1 | 1 | 1 | — | 1 | 1 | 1 | 1 | — | 1 | 1 | 1 | — | 1 | — |
| pbw | | | | | | | | | | | | | | | |
| AO1, | 0.5 | 0.5 | 0.5 | — | 0.5 | 0.5 | 0.5 | 0.5 | — | 0.5 | 0.5 | 0.5 | — | 0.5 | — |
| pbw | | | | | | | | | | | | | | | |
| CAT A, | 0.1 | 0.15 | 0.14 | — | — | 0.14 | 0.1 | 0.1 | — | — | 0.14 | 0.08 | — | — | — |
| pbw | | | | | | | | | | | | | | | |
| CAT B, | — | — | — | — | — | — | — | — | — | — | — | 0.4 | — | — | — |
| pbw | | | | | | | | | | | | | | | |
| CAT C, | — | — | — | 0.1 | 0.1 | — | — | — | 0.1 | 0.1 | — | — | 0.1 | 0.1 | 0.1 |
| pbw | | | | | | | | | | | | | | | |
| NCO A, | 144 | — | — | 144 | 159 | 193 | — | 85.3 | — | — | — | — | — | — | — |
| pbw | | | | | | | | | | | | | | | |
| NCO B, | — | 87 | 85 | — | — | 87 | 76 | — | — | 87 | 85 | 87 | — | 87 | — |
| pbw | | | | | | | | | | | | | | | |
| NCO C, | 71 | — | — | 100 | 100 | — | — | 71 | 90 | — | — | — | 100 | — | 90 |
| pbw | | | | | | | | | | | | | | | |
| NCO | 105 | 105 | 105 | 105 | 105 | 105 | 105 | 105 | 105 | 105 | 105 | 105 | 105 | 105 | 105 |
| Index | | | | | | | | | | | | | | | |

Reinf
Layer²

| | | | | | | | | | | | | | | | |
|---|---|---|---|---|---|---|---|---|---|---|---|---|---|---|---|
| POLY | 60 | 15 | — | 60 | — | 31 | — | — | — | — | 31 | 31 | — | — | 31 |
| B, pbw | | | | | | | | | | | | | | | |
| POLY | 20 | — | — | 20 | 32 | — | — | — | — | — | — | — | 12 | — | — |
| G, pbw | | | | | | | | | | | | | | | |
| POLY | — | — | — | — | — | — | — | — | — | — | — | 40 | — | — | 35 |
| H, pbw | | | | | | | | | | | | | | | |
| POLY | — | 85 | — | — | — | — | — | 25 | — | — | — | — | — | 25 | — |
| I, pbw | | | | | | | | | | | | | | | |
| POLY | — | 5 | — | — | — | — | — | — | 10 | — | — | — | — | — | — |
| J, pbw | | | | | | | | | | | | | | | |
| POLY | — | — | 25 | — | — | 12 | 10 | — | — | 25 | 12 | — | 10 | — | 12 |
| K, pbw | | | | | | | | | | | | | | | |
| POLY | — | — | 25 | — | — | — | — | — | — | 25 | — | — | — | — | — |
| L, pbw | | | | | | | | | | | | | | | |
| POLY | — | — | 50 | — | — | 12 | — | — | 20 | 50 | 12 | — | — | — | 12 |
| M, pbw | | | | | | | | | | | | | | | |
| POLY | — | — | — | — | 25 | 17 | 12 | — | — | — | 17 | 17 | — | — | 17 |
| N, pbw | | | | | | | | | | | | | | | |
| POLY | 20 | — | — | 20 | 53 | — | — | — | — | — | — | — | — | — | — |
| O, pbw | | | | | | | | | | | | | | | |
| POLY | — | — | — | — | — | — | 17 | — | — | — | — | — | 17 | — | — |
| P, pbw | | | | | | | | | | | | | | | |
| POLY | — | — | — | — | — | — | — | 50 | 35 | — | — | — | — | 50 | — |
| Q, pbw | | | | | | | | | | | | | | | |
| DEG, | — | 1 | — | — | — | — | — | — | — | — | — | — | — | — | — |
| pbw | | | | | | | | | | | | | | | |
| EG, | — | — | 4 | — | — | — | 1 | — | 4 | 4 | — | — | 1 | — | — |
| pbw | | | | | | | | | | | | | | | |
| CAT | — | — | 2 | — | — | — | — | 2 | — | 2 | — | — | — | 2 | — |
| E, pbw | | | | | | | | | | | | | | | |
| CAT C, | — | — | 0.2 | — | — | — | — | 0.4 | 0.05 | 0.2 | — | — | — | 0.4 | — |
| pbw | | | | | | | | | | | | | | | |
| H₂O, | — | — | — | — | — | — | — | — | 0.4 | — | — | — | — | — | — |
| pbw | | | | | | | | | | | | | | | |
| NCO A, | 144 | — | — | 144 | 159 | 193 | — | 85.3 | — | — | 193 | 171.5 | — | 85.3 | — |
| pbw | | | | | | | | | | | | | | | |
| NCO D, | — | 136 | — | — | — | — | — | — | — | — | — | — | — | — | 186 |
| pbw | | | | | | | | | | | | | | | |
| NCO E, | — | — | — | — | — | — | 79.8 | — | 179 | 206 | — | — | 79.8 | — | — |
| pbw | | | | | | | | | | | | | | | |
| NCO F, | — | — | 206 | — | — | — | — | 85.3 | — | — | — | — | — | 85.3 | — |
| pbw | | | | | | | | | | | | | | | |
| Index | 110 | 110 | 110 | 110 | 110 | 104 | 104 | 107 | 101 | 110 | 104 | 110 | 104 | 107 | 108 |
| % Glass | 50 | 35 | 45 | 25 | 30 | 50 | 45 | 20 | 30 | 35 | 25 | 30 | 35 | 45 | 30 |

Thick,
mm

| | | | | | | | | | | | | | | | |
|---|---|---|---|---|---|---|---|---|---|---|---|---|---|---|---|
| Part A | 1.8 | 1.8 | 1.8 | 1.8 | 1.8 | 1.8 | 1.8 | 1.8 | 1.8 | 1.8 | 1.8 | 1.8 | 1.8 | 1.8 | 1.8 |
| Part B | 2.2 | 2.2 | 2.2 | 2.2 | 2.2 | 2.2 | 2.2 | 2.2 | 2.2 | 2.2 | 2.2 | 2.2 | 2.2 | 2.2 | 2.2 |
| Part C | 3.5 | 3.5 | 3.5 | 3.5 | 3.5 | 3.5 | 3.5 | 3.5 | 3.5 | 3.5 | 3.5 | 3.5 | 3.5 | 3.5 | 3.5 |

Bar
Coat¹
Thick,
mm

| | | | | | | | | | | | | | | | |
|---|---|---|---|---|---|---|---|---|---|---|---|---|---|---|---|
| Part A | 0.22 | 0.22 | 0.25 | 0.25 | 0.25 | 0.22 | 0.22 | 0.25 | 0.25 | 0.25 | 0.22 | 0.22 | 0.25 | 0.25 | 0.25 |
| Part B | 0.3 | 0.3 | 0.4 | 0.3 | 0.3 | 0.3 | 0.3 | 0.4 | 0.3 | 0.3 | 0.3 | 0.3 | 0.4 | 0.3 | 0.3 |
| Part C | 0.4 | 0.5 | 0.5 | 0.6 | 0.6 | 0.5 | 0.5 | 0.5 | 0.6 | 0.5 | 0.5 | 0.5 | 0.5 | 0.6 | 0.6 |

Bar Coat¹ = Barrier Coating
Reinf Layer² = Reinforced Layer

To demonstrate improved impact resistance, parts of varying thicknesses were made with a formulation corresponding to that given above for Example 12 and tested using a DynaTup instrument by the method described below.

Impact Test Method Using DynaTup Instrument:

Drop tower testing is performed with a DynaTup instrument to determine the impact resistance of a given material. The impact tup is fitted with a 2″×4″ piece of wood having an impact area of 5.25 square inches. Two masses, one weighing 7.9 pounds and one weighing 30.5 pounds may be used. The 7.9 pound mass has an impact velocity of 27.4 ft./second. The 30.5 pound mass has an impact velocity of 18.9 ft./second. The impact energies for these masses are 92 ft./pound for the 7.9 pound mass and 169 ft./pound for the 30.5 pound mass. The test specimen has a width of 6 inches and a length of 12 inches. In the conduct of the test, the test specimen is placed on top of a Styrofoam panel having a thickness of 1.5 inches and the selected mass is dropped onto the sample. Force deflection plots are provided by the instrument manufacturer.

What constitutes a “Passing” impact energy is dependent upon the thickness of the sample.

When subjected to this test using a 30.5 pound mass, an impact energy of greater than 75 ft.-lbs. is needed for a 1.8 mm thick specimen to rate a “Pass”. An impact energy of between 108.7 and 169 ft.-lbs. is needed for a 2.2 mm thick specimen to rate a “Pass”. An impact energy of between 137.3 and 169 ft.-lbs. is needed for a 3.5 mm thick specimen to rate a “Pass”.

The 1.8 mm specimens tested had impact energies of >75 ft-lbs.

The 2.2 mm specimens tested had impact energies of >110 ft-lbs.

The 3.5 mm specimens tested had impact energies of >135 ft-lbs.

Although the invention has been described in detail in the foregoing for the purpose of illustration, it is to be understood that such detail is solely for that purpose and that variations can be made therein by those skilled in the art without departing from the spirit and scope of the invention, except as it may be limited by the claims.

What is claimed is:

1. A composite article having a smooth, bubble-free surface which is sufficiently puncture resistant that at a thickness of 1.8 mm it has an impact energy greater than 75 ft. pounds when subjected to a 30.5 pound DynaTup impact comprising:
a) a barrier coat having a thickness greater than 5 mils which is the reaction product of
(1) an isocyanate component comprising an isocyanate-terminated prepolymer having an NCO content of from 10 to 32% and
(2) an isocyanate-reactive component comprising at least one amine-initiated polyether polyol having a functionality greater than 2 and an OH number of from about 60 to about 700
which is bonded to
b) a fiber-reinforced polyurethane/urea which is the reaction product of
(1) an isocyanate component comprising an isocyanate having an NCO content of from about 6 to about 49% and
(2) an isocyanate-reactive component comprising
(i) at least one alkylene oxide polyether polyol which is initiated with a material that is not an amine having a functionality of at least 2 and an OH Number of at least 28
and/or
(ii) at least one amine-initiated polyether polyol having a functionality greater than 2 and an OH Number greater than 50,
and
(3) 5-60% by weight, based on total weight of fiber-reinforced polyurethane/urea b), fibers having an average fiber length of from 10 to 100 mm in amounts such that the ratio by weight of a) to b) is from 0.1 to 0.5.

2. The composite article of claim 1 in which the isocyanate prepolymer in component (1) of barrier coat a) is a modified diphenylmethane diisocyanate prepolymer.

3. The composite article of claim 2 in which the prepolymer in component (1) of barrier coat a) has an NCO content of from about 18 to about 31%.

4. The composite article of claim 1 in which the amine-initiated polyether polyol of isocyanate-reactive component (2) of barrier coat a) is initiated with an aromatic amine.

5. The composite article of claim 1 in which the isocyanate in isocyanate component (1) of the fiber-reinforced polyurethane/urea b) has an NCO content of from about 23 to about 32%.

6. The composite article of claim 1 in which the isocyanate-reactive component (2) of the fiber reinforced polyurethane/urea b) is polyether polyol (i).

7. The composite article of claim 6 in which the polyether polyol (i) has a functionality of from about 3 to about 4 and an OH Number of from about 260 to about 1050.

8. The composite article of claim 1 in which the isocyanate-reactive component (2) of the fiber reinforced polyurethane/urea b) is polyether polyol (ii).

9. The composite article of claim 8 in which the polyether polyol (ii) has a functionality of from about 2 to 4 and an OH Number of from about 400 to about 700.

10. The composite article of claim 1 in which isocyanate-reactive component (2) of the fiber reinforced polyurethane/urea b) includes both polyether polyol (i) and polyether polyol (ii).

11. The composite article of claim 1 in which fibers (3) of the fiber reinforced polyurethane/urea are included in an amount of from 25 to 40% by weight.

12. The composite article of claim 1 in which fibers (3) of the fiber reinforced polyurethane/urea have an average length of from about 12.5 to 25 mm.

13. The composite article of claim 1 in which the ratio by weight of a) to b) is from about 0.15 to about 0.25.

14. The composite article of claim 1 in which the isocyanate-reactive component (2) of barrier coat a) is a mixture of a trifunctional amine-initiated polyether polyol and a tetrafunctional amine-initiated polyether polyol.

15. The composite article of claim 1 in which the isocyanate component (1) of the fiber-reinforced polyurethane/urea includes polymeric MDI.

16. The composite article of claim 1 in which the isocyanate-reactive component (2) of the fiber-reinforced polyurethane/urea includes an alkylene oxide polyether polyol having an OH Number greater than 1000.

17. The composite article of claim 1 in which the fibers (3) are selected from the group consisting of glass, carbon, ceramic, Kevlar and natural fibers.

18. The composite article of claim 1 in the form of a door panel.

19. An open pour process for the production of a composite, molded article having a smooth, bubble-free surface which is sufficiently puncture resistant that at a thickness of 1.8 mm it has an impact energy greater than 75 ft.-pounds when subjected to a 30.5 DynaTup impact comprising:
a) applying to a mold surface a polyurethane/urea-forming mixture which reacts to form a barrier coat which mixture comprises:
(1) an isocyanate component comprising an isocyanate-terminated prepolymer having an NCO content of from 10 to 32%, and
(2) an isocyanate-reactive component comprising at least one amine-initiated polyether polyol having a functionality greater than 2 and an OH Number of from about 60 to 700
with the equivalent ratio of (1) to (2) being from 0.8 to 1.4,
in an amount such that the barrier coat formed will have a thickness of at least 5 mils,
b) applying to the surface of the barrier coat a polyurethane/urea-forming, fiber containing mixture comprising:
(1) an isocyanate component comprising an isocyanate having an NCO content of from about 6 to about 49%,
(2) an isocyanate-reactive component comprising:
(i) at least one alkylene oxide polyether polyol initiated with a material that is not an amine having a functionality of at least 2 and an OH Number of at least 28
and/or
(ii) at least one amine-initiated polyether polyol having a functionality greater than 2 and an OH Number greater and 50,
in amounts such that the NCO/OH equivalent ratio is from about 0.95 to about 1.1 and
(3) 5-60% by weight, based on total weight of polyurethane/urea-forming, fiber-containing mixture, fibers having an average fiber length of from 10 to 100 mm
in amounts such that the ratio by weight of a) to b) is from 0.1 to 0.5,
c) allowing the polyurethane/urea-forming, fiber containing mixture to cure for a period of from 1 to 6 minutes in the mold which is maintained at a temperature of from 25 to 90° C., and
d) removing the composite from the mold.

20. The process of claim 19 in which the isocyanate-reactive component of the reaction mixture which forms the barrier coat a) comprises:
(A) from about 8 to about 18% by weight, based on total weight of (2), of an amine-initiated polyether polyol having a functionality of 4 and a hydroxyl number of from 500 to 700 and
(B) from about 12 to about 32% by weight, based on total weight of (2), of an amine-initiated polyether polyol having a functionality of 3 and a hydroxyl number of from 100-200,
(C) from about 34 to about 54% by weight, based on total weight of (2), of a polymer polyol,
(D) a chain extender, and
(E) optionally, a catalyst.

21. The process of claim 19 in which the isocyanate-reactive component of the polyurethane/urea-forming, fiber-containing reaction mixture comprises a propoxylated glycerin.
